(19) United States
(12) Patent Application Publication
(10) Pub. No.: US 2006/0294295 A1
(43) Pub. Date: Dec. 28, 2006

(54) DRAM chip device well-communicated with flash memory chip and multi-chip package comprising such a device

(76) Inventor: Yukio Fukuzo, Muenchen (DE)

Correspondence Address: SLATER & MATSIL LLP, 17950 PRESTON ROAD, SUITE 1000, DALLAS, TX, 75252, US

(21) Appl. No.: 11/166,789

(22) Filed: Jun. 24, 2005

(51) Int. Cl. G06F 12/00

(52) U.S. Cl. 711/105; 711/103

(57) ABSTRACT

An SDRAM memory chip device comprises a non-volatile memory controller for operating a non-volatile memory, e.g., a NAND-flash, and a FIFO memory buffer. The FIFO memory buffer serves to operate background store and load operations between a FIFO buffer array and the non-volatile memory, while a host system such as a CPU exchanges data with the SDRAM work memory. The SDRAM memory chip device, therefore, has at least two additional pins as compared with conventional SDRAM standard for generating a set of additional commands. These commands are employed by the FIFO memory buffer to manage the data transfer between the FIFO buffer and each of the non-volatile memory and the volatile SDRAM memory. Two further pins reflecting the flash memory status provide appropriate issuance of load or store signals by the host system.

### TECHNICAL FIELD

The present invention relates generally to semiconductor components and, in various aspects, to a DRAM chip device well-communicated with flash memory chips and multi-chip packages comprising such a device.

### BACKGROUND

Mobile systems such as cellular phones and digital cameras. have recently seen considerable improvements with respect to its system logic as well as its associated memory. According to the specific requirements of such a system, a variety of memory types is nowadays included into mobile systems simultaneously.

For example, cellular phones as well as digital cameras have a system logic, which comprises a number of chips performing specific tasks associated with a mobile system. A cellular phone, e.g., has a base band chip for performing wireless communication tasks and further a digital signal processing (DSP) chip, which may control a charged coupled device (CCD) that is attached to a camera part of the cellular phone.

Recent developments indicate that this system of a communication CPU (CCPU) combined with multiple application CPU's (ACPU) tends to be unified into one combined chip. However, the combination of a CCPU with a number of ACPU's performing communication and digital signal processing tasks into one chip may meet considerable constraints as the number of interfaces needed for associating different memory types with the distinct sections of a respective unified CPU consumes chip area and further requires and unnecessarily large amount of voltage supply.

FIG. 1 illustrates the problem of multiple interfaces. A unified CPU 502 comprises an interface 504, that provides a communication with a low power SDRAM 516 (synchronous dynamic random access memory) via 60 data, command and address lines, or pins respectively, if the SDRAM is a ×32 component. The SDRAM 516 serves as a work memory.

Further, a second interface 506 has 27 data, command and address lines, which provide communication with a NAND-flash memory 514 serving as a permanent storage (non-volatile memory) for large amounts of user data, e.g., image data.

Still further, a third interface 508 has 44 data, command and address lines, which provide communication with a NOR-flash memory 510, which also houses a pseudo-SRAM 512. This latter memory is designed to store program files and code data, since NOR-flash memory 510 generally provides faster read or write access to the cells of that memory, while the storage density is somewhat smaller as compared with the NAND-flash memory 514.

As a result, the CPU 502 has interfaces that sum up to 131 pins according to this prior art example. It has, therefore, been a requirement to reduce the number of interfaces needed to associate different types of memory with a single CPU. The easiest way to proceed would be to unify the system of non-volatile memories (NAND, NOR) for permanent data storage with the work memory of the volatile SDRAM. However, a technical difficulty is raised as to the large difference in clock rate and data transfer speeds between the SDRAM and the flash memory types. For example, SDRAM is clocked at a rate of, e.g., 300 MHz, while flash memory is clocked at rates below 30 MHz.

The need for a unification of the memory interfaces in order to reduce the amount of interface pads on the side of the system logic (i.e., CPU) is further increased due to future technology prospects. Currently, the 130 nm technology employs two CPU chips (CCPU and ACPU), which each require for example 200 pads in order to communicate with other system components via their interfaces. For the year 2007, for which the 80 nm technology is planned, one enlarged unified chip having 500 pads and providing core and application functions, will be introduced to mobile systems. Further shrinking down to the 60 nm technology is then expected to meet problems yet unsolved due to the considerable amount of chip area consumed by the pads.

U.S. Patent Application Publication No. 2005/0027928 A1, by M-Systems Flash Disk Pioneers, Ltd., Israel, propose to cancel NOR-flash and SRAM memory and to use the SDRAM interface for accessing the SDRAM as a work memory and the NAND-flash controller on the same chip device, simultaneously. The NAND-flash memory itself is placed on a second chip, which is connected to the controller by means of an internal interface. However, means to handle the speed differences and to operate the different memory components in a cost and time effective way are not provided according to that proposal.

### SUMMARY OF THE INVENTION

In one aspect, the present invention reduces the costs of implementing a unified system logic, particularly in the case of mobile systems. In a further aspect, the invention reduces costs and efforts for providing work and storage memory to a mobile system logic, and in particular to provide a unified memory having an as small as possible number of interfaces in common with the system logic.

In a further aspect, the invention reduces the power supply needed to operate a system logic and the communication with its associated memory.

In one embodiment, a memory chip device is provided, which includes a first interface, which is arranged to provide a communication between a DRAM of the device and a host system, the DRAM, a controller for controlling operation of a non-volatile memory, a second interface, which is arranged to provide a communication between the controller and the non-volatile memory, and a first-in/first-out memory buffer. The first-in/first-out buffer is connected with the DRAM by means of a first data transfer bus and the controller for controlling operation of the non-volatile memory by means of a second data transfer bus, for buffering data to be transferred between the DRAM, or a host system, and the controller, which controls operation of the non-volatile memory.

Another aspect includes a multi-chip package, comprising the first memory chip device as set in the foregoing, and a second memory chip device comprising the non-volatile memory.

In another aspect, a system includes a central processing unit (CPU), the multi-chip package (MCP) as set in the foregoing, for permanently storing or reading data processed by the CPU and for providing a work memory for program files executed by the CPU, and a single bus interface for providing communication between the CPU and the MCP.

A memory chip device has two interfaces. The first interface is arranged to provide a communication between a DRAM section of the device and an external host system, e.g., a CPU. According to a preferred embodiment, this interface is connected with an external bus, to which the CPU also has access.

The second interface of the memory chip device is arranged to provide a communication between a non-volatile memory controller and the non-volatile memory. According to a preferred embodiment of the invention, this interface does not have access to further components by means of an external bus system, i.e., rather this second interface provides an internal bus between the controller and the non-volatile memory.

As a consequence, the memory chip device associates two different types of memory, e.g., a volatile memory, preferably a DRAM memory, and a non-volatile memory, preferably a flash memory, and most preferably a NAND-flash memory, with a central CPU via one single interface, e.g., the first interface.

A first-in/first-out memory buffer is implemented on the memory chip device and separates a DRAM core section from the non-volatile memory controller section. In particular, this first-in/first-out (FIFO) memory buffer separates the data transfer between the DRAM core section and the non-volatile memory controller section. As a result, data provided to the memory chip device from the host system via the first interface is not directly provided to the non-volatile memory controller, but first has to be input to the FIFO memory buffer.

Further, as the first interface is arranged to provide a communication between the DRAM and the host system, this interface is arranged with sets of command, address, and data lines in agreement with well-known DRAM, or SDRAM standards.

The FIFO memory buffer provides a means to intermediately store the data incoming from the host system (e.g., CPU) or the DRAM core section. Further command signals incoming at the first interface are evaluated in terms of commands valid for operations performed by the non-volatile memory controller and/or the FIFO memory buffer.

According to one aspect of the invention, two additional pins are provided for this purpose with the first interface as compared with a conventional SDRAM interface. These additional pins are arranged to transfer a fifth and a sixth command signal in addition to the conventional /CS, /RAS, /CAS, and /WE command signals. It is noted that the conventional /BSL (bank select signal) is not referred to as a command signal throughout this document. According to another embodiment, a third set of additional pins is arranged to provide a FIFO memory buffer bank select signal in case that memory is also arranged in terms of banks similar to the DRAM core section (which then is an SDRAM).

Using a command decoder, any combination of high or low signal levels emulates a specific command that yields an operation of a control logic of the SDRAM core section. Using these two additional pins, a sufficient set of further commands may be emulated according to embodiments of the invention, which serve to control operation of the two separate data transfer buses mentioned above and further to control the operation of the non-volatile memory by means of the corresponding controller.

According to one aspect of the invention, the non-volatile memory is a flash memory, in particular a NAND-flash memory. In this case, the emulated commands mentioned with the previous aspect relate to a standard set of commands for the NAND-flash controller.

According to a further aspect of the invention, the non-volatile memory controller section further comprises an input/output data buffer. As this buffer may be clocked with a local clock of the non-volatile memory controller, this unit supplies a speed exchange of the data transfer to the non-volatile memory unit.

According to a further aspect, the FIFO memory buffer is provided with a FIFO data processor, which controls the data transfer between the FIFO memory array and the controller section of the non-volatile memory, and further between the FIFO memory array and the DRAM or SDRAM array. Alternatively, the latter data transfer, i.e., on the first data transfer bus, may be managed by an SDRAM control logic, which also performs FIFO memory buffer functions. This is particularly advantageous when the FIFO memory buffer array is organized as an SDRAM memory similar to the SDRAM of the SDRAM core section serving as a work memory. It is then straightforward, to have the SDRAM control logic additionally control the FIFO memory array.

According to this aspect, multiple write or read operations may be performed on the first data transfer bus between the SDRAM array, the FIFO array and the host system (CPU). These operations are treated separately from those write or read operations between the FIFO array and the non-volatile memory. In the particular case that the host system communicates with the SDRAM only, the FIFO array is relieved from this communication and can take part in a second background communication with the non-volatile memory. Accordingly, simultaneous write or read operations can be performed to/from the SDRAM array and to/from the non-volatile memory. The FIFO memory buffer thus serves to optimize the process of the slow store operation to the non-volatile memory in parallel with a fast store operation to SDRAM work memory due to the CPU.

According to a further aspect, one or two further pins are provided to the SDRAM interface, which serve for transferring signal flags from the chip device to the host system (e.g. the CPU). These flags transfer a ready or busy status of the non-volatile memory and/or the FIFO memory buffer. The host system is thus allowed to check these status flag signals in order to issue appropriate command signals, resulting in suitable commands, when writing to the SDRAM array, the FIFO array or the non-volatile memory, respectively.

Although the invention is illustrated and described herein as embodied in a memory chip device, a multi-chip package and a system including a CPU, it is nevertheless not intended to be limited to the details shown, since various modifications and structural changes may be made therein without departing from the spirit of the invention and within the scope and range of equivalents of the claims.

The chip device, package and system of the invention, however, together with additional objects and advantages thereof will be best understood from the following description of specific embodiments when read in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 shows an overview of a CPU and its associated memory according to prior art;

FIG. 2, same as FIG. 1, but according to an embodiment of the invention;

FIG. 3 shows a schematic block diagram of a memory chip device according to an embodiment of the invention;

FIG. 4 shows a more detailed block diagram of a memory chip device according to an embodiment of the invention; and

FIG. 5 shows a simplified block diagram illustrating different load and store operations that may be performed according to an embodiment of the invention.

The following list of reference symbols can be used in conjunction with the figures:
10 DRAM core section
12 DRAM interface
14 Pins
20 multi-port FIFO input/output buffer
30 flash memory controller section
32 flash memory interface
40 DRAM chip device
50 host system, CPU
60 flash memory chip device
110 DRAM clock
120 DRAM and FIFO control logic
130 bank select component
140 mode register
150 command decoder
160 column address buffer
170 row address buffer
180 data control (1^{st} bus)
190 DRAM memory array
192 1^{st} data transfer bus
210 FIFO data processor
211 FIFO timing generator
280 data control (2^{nd} bus)
290 FIFO memory array
294 2^{nd} data transfer bus
310 flash memory clock
320 flash controller
330 source address register
340 destination address register
380 flash data register
385 ECC logic
390 flash input/output buffer
502 CPU
504,504′ interface
506,520 second interface
508 third interface
510 NOR-flash memory
512 pseudo-SRAM
514,514b NAND-flash memory
514a NAND-flash controller system
516, 516′ SDRAM

### DETAILED DESCRIPTION OF ILLUSTRATIVE EMBODIMENTS

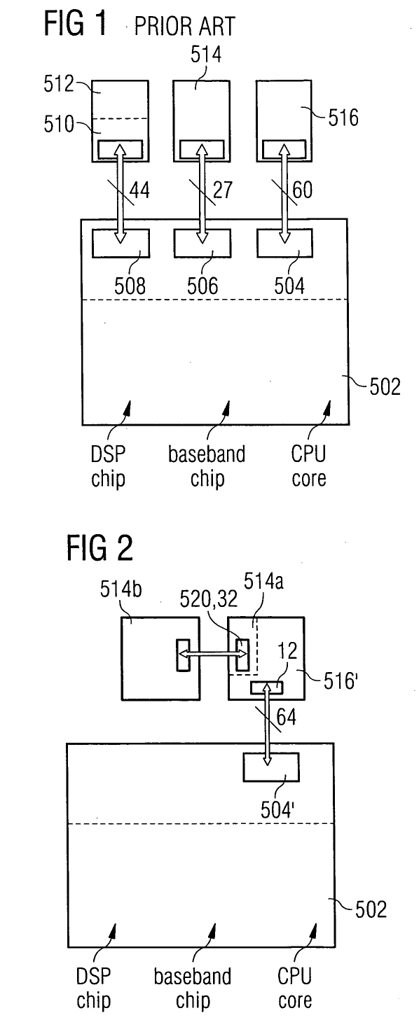

FIG. 2 shows an overview block diagram of a system comprising a CPU 502, an SDRAM work memory 516′ and a NAND-flash memory 514b for permanent storage of user data and executable program files according to a first embodiment of the invention. CPU 502 has a single (first) interface 504′ that provides communication with both the volatile work memory 516′ and the non-volatile storage memory 514b. The width of this bus is increased to 64 data, command and address lines, or pins on the corresponding memory chip device, as compared with the 60 lines or pins shown in the prior art example of FIG. 1.

However, as interface 504′ is the only interface left on the CPU side, the total number of lines, or pads required on the CPU board 502, is reduced from 131 to 64 according to this specific example. Therein, the flash memory 514b is accessed via a second interface 520 from the SDRAM work memory 516′. More precisely, the SDRAM work memory 516′ comprises a NAND-flash controller section 514a, which controls operation of the NAND-flash memory 514b. The 4 additional pins provided via the first interface 504′ serve to yield additional commands for operating the flash controller section 514a as well as a FIFO memory buffer section provided with the SDRAM memory chip device.

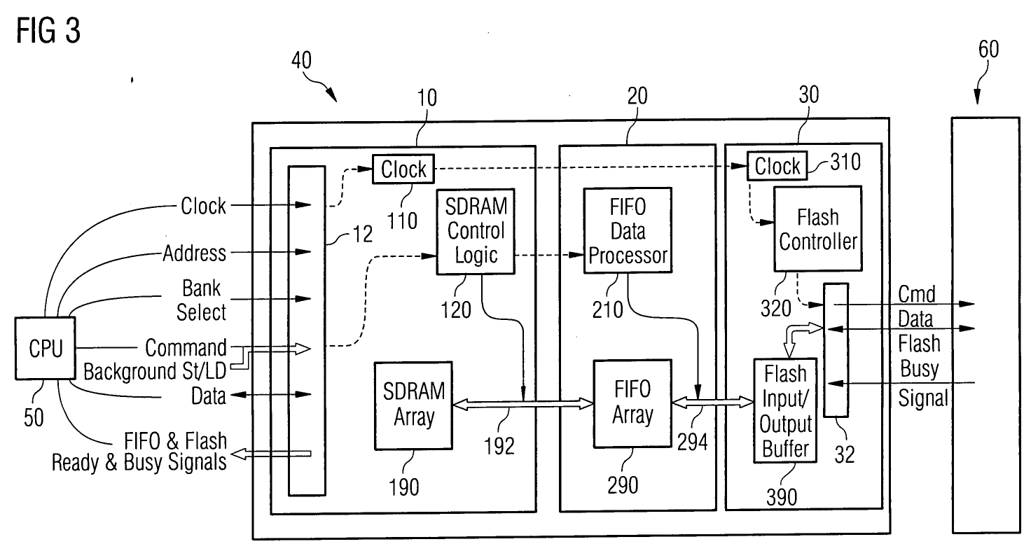

FIG. 3 shows a schematical block diagram with a similar SDRAM memory chip device 40, which is interfaced with a flash memory device 60 according to a second embodiment of the present invention. The flash memory device 60 used in this embodiment is a NAND-flash memory.

The SDRAM memory chip device 40 according to this embodiment may be divided into three sections: an SDRAM core section 10, a FIFO buffer section 20 and a flash controller section 30. Nevertheless, all three sections may be manufactured on the same chip or die, while the flash memory device 60 accessed via the interface directly from the SDRAM memory device may be manufactured on another chip, or die.

The SDRAM core section 10 comprises an interface 12 to a host system such as a central processing unit 50 (CPU). The interface 12 comprises a plurality of pins 14, which are arranged to adhere to the SDRAM standard. According to their functions, the pins may be grouped into those transferring clock signals, address signals, command signals, bank select signals and data signals. As indicated in FIG. 3 by the double arrows, additional pins are provided to the interface as compared with the SDRAM standard. These additional pins are arranged to transmit signals, which yield control of background store and load operations with respect to those data intended for permanent storage within the NAND-flash memory, while data are transferred between the host CPU 50 and the SDRAM array 190.

The first interface 12 further comprises pins, which signal the ready or busy status of the FIFO buffer section 20 and/or the NAND-flash memory 60 from the chip device 40 to the CPU 50.

The SDRAM core section 10 has a clock generator 110, which generates an internal clock (running at, e.g., 130 MHz) from the incoming clock signals. This clock is valid for the SDRAM core section 10 and the FIFO memory buffer section 20. The clock is forwarded to the flash controller section 30, where a flash clock generator 310 generates a flash clock from the SDRAM section clock, which is valid for this section, e.g., at 20 MHz.

Each of the three sections 10, 20, 30 of the chip device 40 comprises a memory array or buffer with registers. The SDRAM core section 10 comprises an SDRAM memory array 190 with a size of, e.g., 64 MB. The FIFO memory buffer 20 also comprises a FIFO SDRAM array 290 with a size of 2 MB. The flash controller section 30 comprises a data register 380 attached to the input/output buffer 390 having a size of 2 kB.

Both arrays 190, 290 are connected by a first data transfer bus 192. This first data transfer bus is controlled by the SDRAM control logic 120, which receives commands emulated from the command signals incoming at the interface 12. The first data transfer bus may have a width of 8, 16, 32, or 64 bits and is arranged either for bi-directional data transfer or consists of each a unidirectional read and write bus.

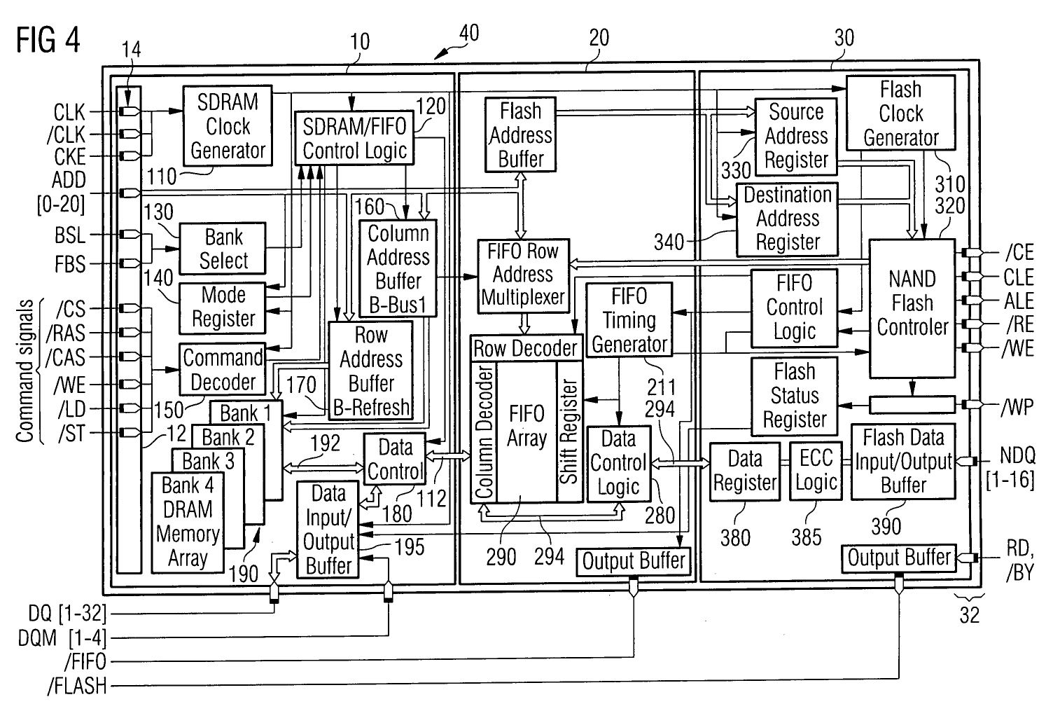

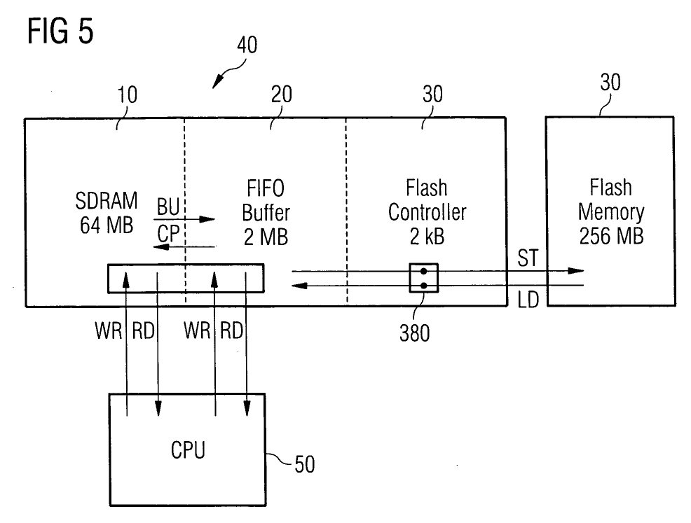

A FIFO data processor 210 controls a second data transfer bus 294 in response to emulated background store and load commands. The second data transfer bus 294 connects the FIFO memory array 290 with a flash input/output buffer 390, that is associated with data registers 380 and an ECC logic 385 (see detailed FIG. 4). This latter buffer and register section performs the transfer speed adaption with regard to the slower flash controller clock 310. The second data transfer bus 294 may have a width of 8, 16, 32, or 64 bits and is arranged either for bi-directional data transfer or consists of each a unidirectional read and write bus.

A standard NAND-flash interface 32 provides the data transfer and the command control to or from the flash memory device 60. Therein, the NAND-flash controller 320, which controls this operation is positioned on the present memory chip device 40.

FIG. 4 shows a more detailed block diagram according to the second embodiment of the invention. Herein, the first interface 12 comprises multiple pins 14 adhering to the SDRAM standard.

The pin definitions of the clock signals are:

CLK: system clock input with other signals being referenced to the CLK rising edge;

/CLK: inverted signal of system clock, available for DDR memory (double data rate) with referencing of signals to the falling edge;

CKE: clock enable signal

The pin definitions of the command signals are:

/CS: chip select and command active signal;

/RAS: row active signal

/CAS: column active signal

/WE: write or read enable signal

/LD: data load enable signal

/ST: data store enable signal

The command signals /LD and /ST go beyond the SDRAM standard and are provided additionally to interface 12 for controlling background load (/LD) and for controlling a background store (/ST) of data intended for long duration storage within the non-volatile memory. Each of the command signals may attain a high or low level with respect to a clock timing.

Counting CKE as a command signal, a set of at least 13 commands to operate the SDRAM core section 10 may be emulated from any combination of signal levels (low or high) of conventional SDRAM signals CKE, /CS, /RAS, /CAS, /WE by means of a command decoder 150. A so-called command truth table may be set up thereof, which associates available commands with particular combinations of signal levels, i.e., high or low, of the incoming command signals at the respective pins. The commands are received and executed by an SDRAM core logic 120, which also performs control tasks with respect to the FIFO buffer section 20.

Using the additional pins with respective signals: /LD and /ST, sets of further commands may be established according to combinations of signal levels with those of the signals stated above by means of the command decoder 150. In this embodiment, these are nine additional commands. Four of these commands relate to NAND-flash commands: RST (reset), STR (status register), IDR (chip ID register), ABE (automatic block erase). Two of the nine additonal commands relate to the control of the data transfer between the SDRAM FIFO memory array 290 and the flash memory input/output buffer 390 (second data transfer bus 294): /LD (background load), /ST (background store). Further, three additional commands of the set of nine commands relate to controlling the data transfer between the SDRAM core memory array 190 and the FIFO memory array 290: CP (automatic copy), BU (automatic back up) and DAS (destination-address-strobe).

These three latter commands CP, BU and DAS are performed automatically, i.e., not as a background operation, directly in response to the command signals issued by the CPU. However, commands /LD and /ST are background operations. Accordingly, the duration of the performance is not previously known and further signals FIFO and FLASH with respective flag signal pins are needed as described below in order to provide a feedback to the CPU 50 of what is currently the status in the background (between FIFO buffer memory section 20, flash controller section 30 and flash memory device 60).

Once being emulated, the commands are received by either the SDRAM core logic 120 or the FIFO timing generator 211, which represents the data processor 210 shown in FIG. 3, for controlling the respective data transfer busses. The four flash memory control commands are forwarded to the NAND-flash controller 320.

The device further has indicator signals /FIFO and /FLASH, which are sent to the CPU 50 via respective two additional pins of interface 12. These signals serve to flag the status of the FIFO buffer section 20 and the flash controller section 30, or the flash memory device 60, respectively, to the CPU 50. The CPU 50 may issue appropriate command signals independent of these signals flagged.

SDRAM core section 10 further comprises—according to this embodiment—a mode register 140 and a bank select component 130. The bank select component 130 buffers the bank select signal incoming at a respective pin of the first interface 12. Using this signal, one of the banks 0-3 of the array 190 may be selected for read or write access in agreement with the SDRAM standard. In addition to the bank select pin (pin definition: BSL), a further pin may optionally be provided to select a bank of the FIFO memory buffer array 290, if this is array 290 as well arranged in terms of banks according to the SDRAM standard. In FIG. 4, a pin definition FBS (FIFO buffer select) is associated with this signal.

SDRAM core section 10 further comprises row and column address buffers 160, 170 to receive addresses via pins ADD[0:20]. A data control component 180 is controlled by the SDRAM/FIFO control logic 120 in order to manage the data transfer on the first data transfer bus.

A background load operation in accordance with this embodiment may be performed as follows: An /LD command (background load command) is issued (e.g., with /CS and /LD being “low” and /RAS, /CAS, /WE, /ST and CKE being “high”) with a source address “SA” of a NAND-flash memory page provided via the address pins ADD by the CPU 50. SA relates to the page of the NAND memory to be loaded into the FIFO buffer section.

Immediately, the /FLASH flag is set via the respective pin. With a DAS command (destination address strobe: e.g., with /CS, /LD and /ST being “low” and /RAS, /CAS, /WE and CKE being “high”) issued three clock periods later according a predefined rule, a bank of FIFO memory buffer array 290 is selected (command FBS) and an address “DA” within FIFO memory buffer array 290 is provided as a destination address via address pins ADD.

Next, the CPU 50 performs an automatic foreground write operation to the SDRAM array 190. An ACT command is issued three clock periods after the DAS command in order to activate a row (e.g., with /CS and /RAS being “low” and /CAS, /WE, /ST, /LD and CKE being “high”). A bank address (command BSL) and a row address “RA” (via address pins) is transmitted therewith. Then a write WR (e.g., with /CS, /CAS and /WE being “low” and /RAS, /LD, /ST and CKE being “high”) is performed with transferring a column address CA to the column address buffer 160.

In response to this command, a data sequence of eight bits, i.e., a word, is transferred via DQ pins DQ[1-32] of interface 12 into SDRAM array 190 and written into those memory cells having the logical row, column and bank address provided as stated above.

In the meantime, the background load from the NAND-flash memory to the FIFO buffer has started. The addresses “SA” and “DA” were transferred to respective destinations and source registers 330, 340 of the flash controller section 30. The /LD command is recognized by the FIFO timing generator 211.

Flash controller section 30 has a generic interface 32 to communicate with the flash memory device 60. This second interface 32 is provided with pins having a definition as follows:

/CE chip enable with active low

CLE command latch enable with active high

ALE address latch enable with active high

/RE read enable

/WE write enable

/WP write protect enable

RD,/BY ready or busy input signal

NDQ[1-16] input/output ports for address, command and data

The pins represent a NAND-flash interface standard arrangement and are not amended as compared with prior art NAND-flash memory interfaces.

Ground level and voltage supply pins are not shown in the diagrams for simplicity with respect to both interfaces 12 and 32.

The NAND-flash controller 320 retrieves page data from the NAND address “SA” via NDQ pins of the interface 32. The data are intermediately stored in data register 380. FIFO timing generator 211 then starts data control logic 280 to transfer the registered data to the FIFO memory buffer array 290, where they are stored under the destination address “DA”.

During this operation, the /FIFO flag is also issued in order to signal to the CPU 50 that the FIFO memory buffer is busy. As a result of that, the CPU 50 is not allowed to store or load data to/from the FIFO memory buffer array 290 until the /FIFO flag returns to the level “high” (when the signal is defined as active “low”).

FIG. 5 provides an overview of the load, store, read and write commands available according to this embodiment of the invention. Command signals /LD and /ST are background operations (on the second data transfer bus) controlled by flash controller 320 and timing generator 211, BU (back-up) and CP (copy) are automatic foreground operations (on the first data transfer bus) directly initiated by the CPU 50 and controlled by SDRAM/FIFO control logic 120. Write and read commands (WR, RD) can be performed alternatively on both the SDRAM core array 190 and the SDRAM FIFO memory array 290 by the CPU 50.

What is claimed is:

1. A memory chip device, comprising:
a dynamic random access memory;
a first interface arranged to provide a communication between the dynamic random access memory and a host system;
a controller for controlling operation of a non-volatile memory;
a second interface arranged to provide a communication between the controller and the non-volatile memory; and
a multi-port first-in/first-out memory buffer, which is coupled with:
a) the dynamic random access memory by means of a first data transfer bus, and
b) the controller for controlling operation of the non-volatile memory by means of a second data transfer bus,
wherein the multi-port first-in/first-out memory buffer buffers data to be transferred between said dynamic random access memory or the host system and said controller.

2. The memory chip device according to claim 1, wherein the dynamic random access memory comprises a synchronous dynamic random access memory (SDRAM).

3. The memory chip device according to claim 1, wherein the non-volatile memory comprises a flash memory.

4. The memory chip device according to claim 3, wherein the flash memory device comprises a NAND-flash memory.

5. The memory chip device according to claim 1, wherein the non-volatile memory is arranged on a second memory chip device, which is connected to the memory device solely by means of said second interface.

6. The memory chip device according to claim 1, wherein the first interface comprises a subset of pins that are arranged to transfer a set of command signals from the host system to said memory device, said command signals being adapted to emulate first commands for controlling operation of the dynamic random access memory by means of a control logic, and to emulate second commands for controlling operation of the non-volatile memory by means of the controller.

7. The memory chip device according to claim 6, wherein the first interface is arranged to comprise a subset of at least six pins that are arranged to transfer the set of command signals from the host system to said memory device, that at least six pins including pins to carry:
a chip select signal;
a row active signal;
a column active signal;
a write enable signal;
a background load signal; and
a background store signal.

8. The memory chip device according to claim 6, further comprising a command decoder coupled to said subset of pins for performing the emulation of said commands independent of a combination of signal levels of said command signals.

9. The memory chip device according to claim 8, wherein said command decoder is further arranged to emulate third commands for controlling data transfer between the dynamic random access memory and the first-in/first-out memory buffer, and fourth commands for controlling data transfer between the controller for operating the non-volatile memory and the first-in/first-out memory buffer, and independent of the combination of signal levels of said command signals.

10. The memory chip device according to claim 1, wherein said first-in/first-out memory buffer comprises a memory array.

11. The memory chip device according to claim 10, wherein the memory array of said first-in/first-out memory buffer comprises a dynamic random access memory array.

12. The memory chip device according to claim 1, wherein the first-in/first-out memory buffer comprises a first-in/first-out data processor that is arranged to control the data transfer via the first data transfer bus.

13. The memory chip device according to claim 12, wherein said first-in/first-out data processor is further arranged to control a data transfer via the second data transfer bus.

14. The memory chip device according to claim 13, wherein the data processor is arranged to perform a data transfer via the second bus simultaneously with a data transfer between the dynamic random access memory and the host system.

15. The memory chip device according to claim 1, wherein the dynamic random access memory includes a control logic that is arranged to control a data transfer via the first data transfer bus.

16. The memory chip device according to claim 15, wherein the first-in/first-out memory buffer comprises a first-in/first-out data processor that is arranged to control a data transfer via the second data transfer bus.

17. The memory chip device according to claim 16, wherein the control logic and the data processor are arranged to perform a data transfer via the second bus simultaneously with a data transfer between the dynamic random access memory and the host system, respectively.

18. The memory chip device according to claim 1, wherein the controller for operating the non-volatile memory further comprises a data input/output buffer unit arranged to adapt a speed of said data transfer on said second data transfer bus due to the dynamic random access memory to that of the controller for operating the non-volatile memory.

19. The memory chip device according to claim 1, wherein said first interface comprises a first additional signal pin, which is arranged to provide a first signal to said host system, said first signal reflecting a status of said first-in/first-out memory buffer to be busy.

20. The memory chip device according to claim 1, wherein said first interface comprises a second additional signal pin, which is arranged to provide a second signal to said host system, said second signal reflecting a status of said non-volatile memory to be busy.

21. A multi-chip package, comprising:
a first single-chip memory device, comprising a DRAM-array, a first-in/first-out memory buffer array and a controller for controlling operation of a non-volatile memory; and
a second single-chip memory device, the second single-chip memory device housed in the same multi-chip package as the first single-chip memory device comprising the non-volatile memory.

22. The multi-chip package according to claim 21, wherein the non-volatile memory is a NAND-flash memory.

23. The multi-chip package according to claim 21, wherein the first single-chip memory device comprises:
a dynamic random access memory;
a first interface arranged to provide a communication between the dynamic random access memory and a host system;
a controller for controlling operation of a non-volatile memory;
a second interface arranged to provide a communication between the controller and the non-volatile memory; and
a multi-port first-in/first-out memory buffer, which is coupled with the dynamic random access memory by means of a first data transfer bus, and the controller for controlling operation of the non-volatile memory by means of a second data transfer bus, the multi-port first-in/first-out memory buffer for buffering data to be transferred between said dynamic random access memory, or the host system, and said controller.

24. A system, comprising:
a central processing unit (CPU);
a multi-chip package (MCP) for permanently storing or reading data processed by the CPU and for providing a work memory for program files executed by the CPU: comprising
a first single-chip memory device, comprising a DRAM-array, a first-in/first-out memory buffer array and a controller for controlling operation of a non-volatile memory; and
a second single-chip memory device, the second single-chip memory device housed in the same multi-chip package as the first single-chip memory device comprising the non-volatile memory; and
a single bus interface for providing communication between the CPU and the MCP.

25. The system according to claim 21, wherein the first single-chip memory device comprises:
a dynamic random access memory;
a first interface arranged to provide a communication between the dynamic random access memory and a host system;
a controller for controlling operation of a non-volatile memory;
a second interface arranged to provide a communication between the controller and the non-volatile memory; and
a multi-port first-in/first-out memory buffer, which is coupled with the dynamic random access memory by means of a first data transfer bus, and the controller for controlling operation of the non-volatile memory by means of a second data transfer bus, the multi-port first-in/first-out memory buffer for buffering data to be transferred between said dynamic random access memory, or the host system, and said controller.
